(19) United States
(12) Patent Application Publication
(10) Pub. No.: US 2008/0173054 A1
(43) Pub. Date: Jul. 24, 2008

(54) OPEN COMPOSTING BIOFILTER

(75) Inventor: Fatih Buyuksonmez, San Diego, CA (US)

Correspondence Address: PASSE' INTELLECTUAL PROPERTY, LLC, 1717 BRASSFIELD RD., RALEIGH, NC, 27614, US

(73) Assignee: San Diego State University Research Foundation, San Diego, CA (US)

(21) Appl. No.: 11/625,319

(22) Filed: Jan. 20, 2007

(51) Int. Cl. A01N 25/00

(52) U.S. Cl. 71/64.07

(57) ABSTRACT

The present invention relates to control of volatile emissions from a pile of composting organic material. Specifically, the present invention relates to covering the composting pile with a blanketing layer of finished compost material. The invention further relates to mixing finished compost with composting material either by itself or mixing the blanketing layer into the composting material during aeration. The invention also discloses adding additional blanketing layers of finished compost as previous layers are mixed into the composting material during aeration.

### BACKGROUND OF THE INVENTION

1. Field of the Invention

The present invention relates to biofilter systems for odor and pollutant emission control for use with new or active compost piles. In particular, the present invention relates to layering stabilized compost on a new or active compost pile for the reduction of emissions of volatiles including noxious odors from the new or active compost pile.

2. Description of the Related Art

The production of compost results in the emission of a number of volatile organic compounds (VOC). These compounds are both pollutants and in some cases odor causing compositions and include terpenes, ammonia and amines, carbon dioxide, methane, sulfur compounds organic acids and the like. These compounds are considered anywhere from just malodorous to toxic to environmentally unacceptable. Accordingly, since there is a tremendous desire to control all the volatile emissions during composting, there have been a number of methods introduced over the years to control the volatile emissions produced during composing.

One of the most common methods to control volatiles during composting is to produce the compost in a closed environment. Whether a small container or a large facility, close the system to outside air is effective to control volatiles. While filtering the air and the like are necessary before release to the atmosphere, a closed environment allows control of escape of gasses. For example in U.S. Pat. No. 6,551,818 there is disclosed a filtering system comprising a biofilter cartridge having a polygonal cross section with wall side openings. The cartridge can then be filed with compost as a biofiltering agent. While highly effective, it requires costly equipment and only is effective in closed systems like a production building.

Another method for producing compost which is designed to produce compost cheaply is to do it in large open fields away from other buildings or populated areas. The windrow system of composting involves the aeration of horizontally extended piles formed by a front-end loader or windrow turner. Extended piles are generally 1.5 to 3 m in height, and width and only limited in length by the size of the composting pad. Aeration can be achieved by mechanical turning and/or the delivery of air from the base of the windrow.

By exposing the emissions to sufficient outdoor airflow, the volatiles are effectively dissipated before reaching areas outside the composting piles.

As the country becomes more crowded this open field method has started to become a problem. In addition, the EPA is proposing that volatile emissions from composting activities be cut by over 60% from current levels. While a closed building certainly can solve the problem, the cost and practicality of building a building to cover huge acreage that some of these compost piles take up, makes a building an impossible solution.

Other solutions have been attempted to control volatile emissions on these large outdoor composting piles, but have yielded marginal results at high cost. For example, misting of the compost pile is frequently done as a means of controlling volatiles, however, testing has shown that the emission lowering effect is minimal. Likewise, odor neutralizing agents and oxygen release compounds are routinely sprayed on composting piles, yet, these compounds have proven that they can not consistently control volatile emissions. Collectively, these methods are costly and none of the currently used methods are capable of lowering the composting emissions sufficiently to meet current composting needs let alone the new EPA proposals.

Current methods of composting treatment to control volatile emissions are costly and relatively ineffective. If large scale outdoor composters are to continue to produce compost in their facilities without huge construction expenses, it is desirable that new technology be available that can control volatile emissions in a relatively easy and cost-effective manner.

### BRIEF SUMMARY OF THE INVENTION

It has been discovered in the present invention, that a system of covering new and composting piles with a layer of finished compost or of including finished compost into the pile can achieve the objects described above and more as will readily be seen by the disclosure examples and claims herein. The finished compost acts as a biofilter for the undesirable volatile emissions. The resultant present invention is far more effective at controlling volatile emissions than any methods current used and at a cost far less than most methods available to the composter today.

In one embodiment of the invention there is a method for reducing the volatile emissions from a pile of composting organic material comprising covering the composting pile with a blanket layer of finished compost.

In yet another embodiment of the invention there is presented a method for reducing the volatile emissions from a pile of composting organic material comprising adding a sufficient amount of finished compost to the pile to reduce the measurable volatile emissions from the pile.

### BRIEF DESCRIPTION OF THE DRAWINGS

FIG. 1 is a comparison graph of a single blanket layer of finished compost of the invention measuring terpenes.

FIG. 2 is a comparison graph of mixing finished compost and measuring terpenes.

FIG. 3 is a comparison graph of using misting to control terpene emissions.

FIG. 4 is a comparison graph of using an odor neutralizing agent to control terpene emissions.

FIG. 5 is a comparison graph of a single blanket layer of finished compost of the invention and measuring of ammonia emission.

FIG. 6 is a comparison graph of mixing finished compost with composting material and measuring ammonia emission.

FIG. 7 is a comparison graph using misting to control ammonia emissions.

FIG. 8 is a comparison graph using an oxygen release compound to control ammonia emissions.

FIG. 9 is a drawing of the apparatus used to test the present invention

### DETAILED DESCRIPTION OF THE INVENTION

The general description of the invention and how to use the present invention are stated in the Brief Summary above. This detailed description defines the meaning of the terms used herein and specifically describes embodiments in order for those skilled in the art to practice the invention. The above interests in controlling volatile emissions while composting, for example while using the windrow system, are explained and the objects of the present invention met as can be seen readily from the disclosure which follows and thus met by the present invention.

As used herein the term “pile of composting organic material” refers to organic material which is newly started to compost or which is in the process of composting. In both case, composting organic material off-gasses or emits a number of different undesirable volatile compounds and compositions. This off-gassing is a characteristic of composting organic material to be treated by the present invention. In one embodiment, the method used to compost is the windrow method of composting where long rows of composting material are laid out and in a further embodiment the rows are outside.

As used herein “finished compost” refers to compost that has finished breaking down and thus has essentially finished off-gassing. The finished composting material can be the same type that is from the same organic materials or different organic materials than the composting organic material it is used on. While finished compost may have some “smell” it is clear to those skilled in the art that the major gasses especially those sought to be regulated by the EPA have essentially finished being released from the compost. It is clear that someone in the composting business will have a ready source of finished compost merely needing to save some of each batch of compost to use in the production of the next batch. The compost farmer thus never has to purchase any products and the cost is relatively cheap if not free.

As used herein the term “blanket layer” refers to covering a pile of composting material such that essentially no composting material is exposed directly to the air. In general, it would be about 1 or 2 inches or more in depth covering the exposed part of the composting material pile. In one embodiment, the blanket layer is between about 2 and 8 inches thick. In actuality, the actual depth will be adjusted based on the thickness, width, depth and the like of the composting pile. Based on the disclosure herein, one skilled in the art will be able to determine both the minimum and the optimum thickness of the blanket layer for each individual composting pile. One can also balance the thickness against the cost of reincorporating the composting material and the diminishing return on bio-filtering as the blanket layer gets over a particular thickness which will be different for different piles of compost.

As used herein “turning the composting pile” refers to the process that's used in composting to insure even compost results, for example, in the windrow method, of turning the pile over to expose different parts of the composting mixture to the air. This turning necessitates mixing the blanket layer of the finished compost to be mixed into the composting pile. While as taught herein that is also effective although less so at reducing volatile emissions, the blanket layer when mixed into the pile continues to control volatile emissions. Maximum control can be obtained by adding (reapplying) an additional blanketing layer of finished compost after the pile is turned. This addition can be done for every single time the pile is turned or can be done for selective turnings or for a selected number of turns in the process even when a higher number of turns occur.

By “covering” as used herein is meant to lay down a layer of finished composting material over the composting pile. This can be accomplished by hand for example by use of a shovel but could also be accomplished by backhoe, bucket loader or via use of a windrow spreader. As discussed above, the actual thickness of the layer that covers the pile may vary and in some embodiments is at least 2 inches in depth. The actual depth is within the skill of the art after viewing the present disclosure. It is also possible that the layer can vary in thickness in different parts of the pile for example the covering layer being thicker where the pile is thickest and shallower where the pile is shallowest.

It is also taught herein that mixing of finished compost into the composting material also reduces volatile emissions although not to as great a degree as with the blanketing method taught above. As will be seen from the examples if one extrapolates the data one can see how as little as the addition of 5% by volume of finished compost to the composting pile reduces emissions. By the time 12% has been added, this amount provides a very significant reduction in emissions.

So, in general, the present invention is accomplished by collecting an amount of finished compost, either from previous batches or from some other source. The new composting material is laid out in the desired fashion e.g. the windrow method. Then at a selected point in time either a blanket layer of finished compost is laid over the composting pile or a selected amount of finished composted is admixed with the composting material. If attempting to meet a severe reduction in emissions, the blanket layer will provide a significantly better result.

Likewise when the composting pile is turned for aeration additional composting material can be either admixed or used to blanket the turned pile with additional finished compost in the desired amount. The optimum results would be obtained by placing a blanket layer of finished compost over the composting pile at the start of composting, followed by an additional blanketing layer of finished composting material over the pile each time it is turned.

Likewise, individual spots on the pile can be monitored for emissions. Where it appears that emissions are greater in a particular area than desired the blanket layer can be increased in depth in a particular spot or where necessary the entire layer increased in depth as needed. Once again the addition can be by hand or via know techniques using machinery and is within the intended scope of the claimed invention.

### EXAMPLES

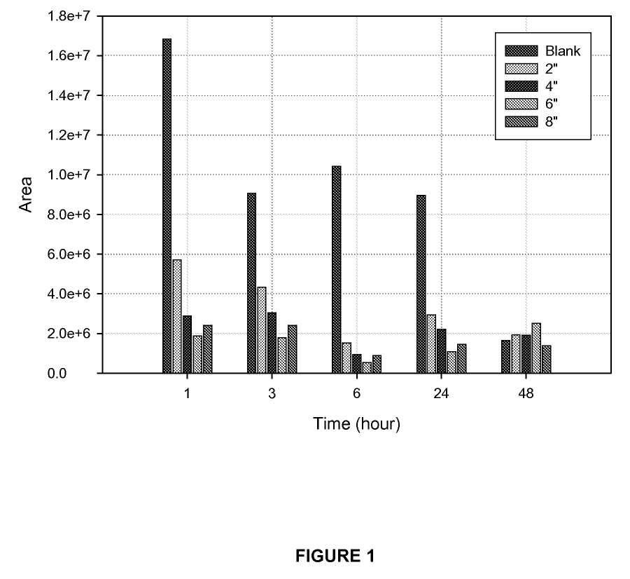

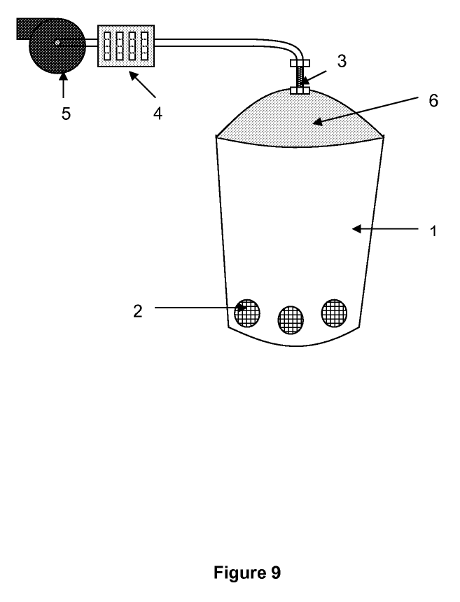

The volatile emissions treatment of the present invention was tested against some of the standard methods of treating composting material for odor and volatile emission control. The apparatus used to test the present invention is illustrated in FIG. 9. Testing was done by converting a standard plastic garbage can 1. A series of aeration ports 2 were placed towards the bottom of the garbage can 1 sides. A Supelco Orbo-32 Charcoal tube was connected to the lid 6 of garbage can 1 for collecting emissions. Emissions were controlled by attaching vacuum pump 5 and flow meter 4 external of the charcoal tube 3 so that a constant flow from the test garbage can 1 can be maintained. The garbage can 1 was then filled with new composting materials and a number of methods used to test volatile emission control. Both terpenes and ammonia were measured and the results are graphed in FIGS. 1 through 8.

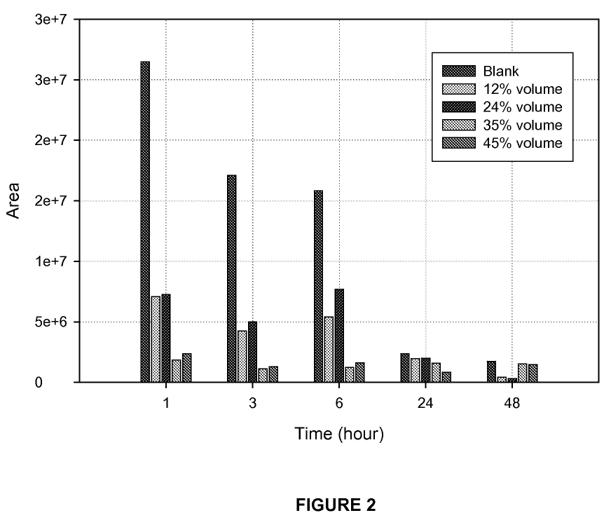

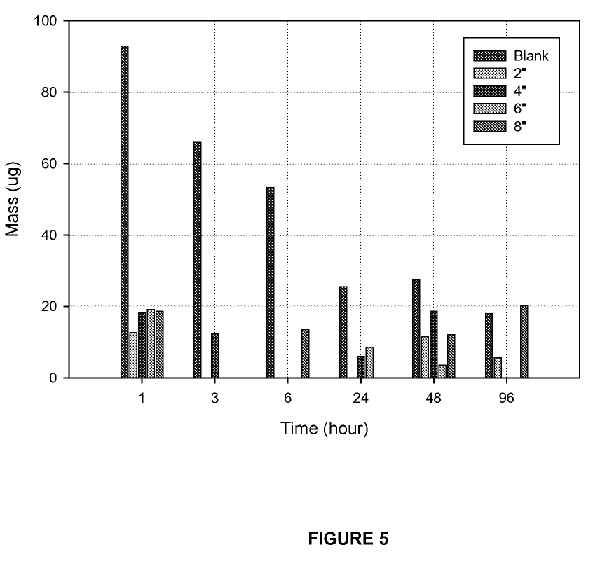

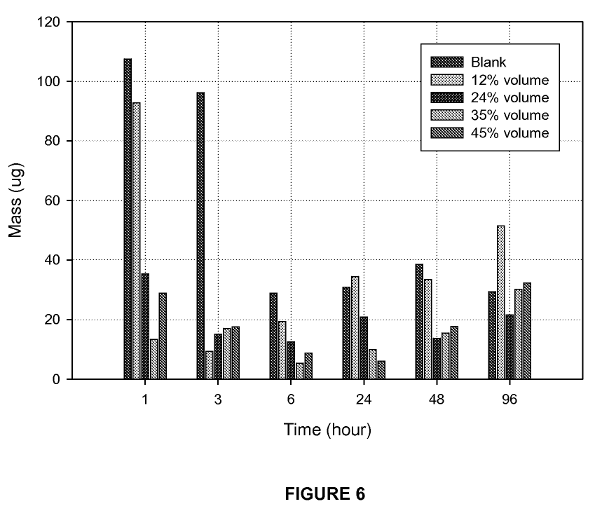

Two methods of odor control were tested of the present invention and 3 currently being used methods were also tested. In the present invention a blanket layer of finished compost was used in FIGS. 1 and 5 and measuring terpenes and ammonia. Different thicknesses of the blanket layer were used from 2 to 8 inches with a control of no blanket layer for comparison. Likewise, in FIGS. 2 and 6, finished compost were mixed with new composting materials and the same measurements made. Compost was added from about 12% by volume to 45% by volume with a control of no finished compost used.

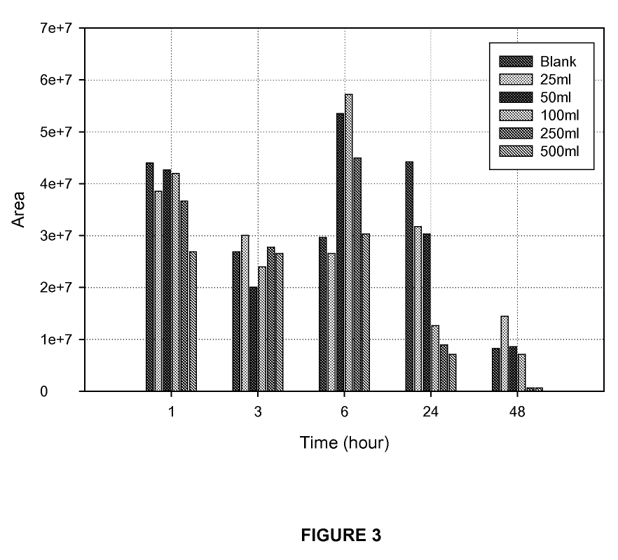

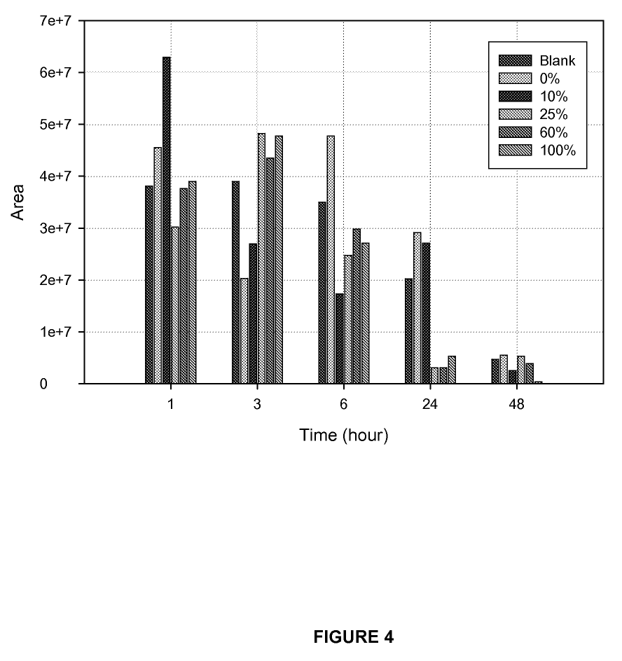

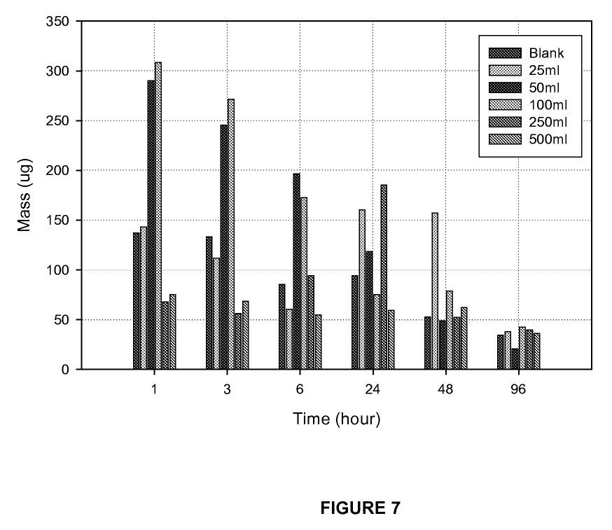

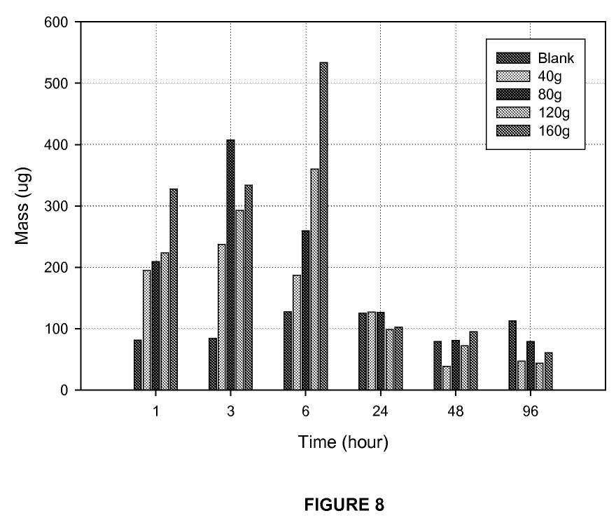

The remaining figures show similar test results using known odor control methods. FIG. 3 and FIG. 7 show the results of misting the top of the compost pile. While the remaining FIGS. 4 and 8 show the results of using odor neutralizing agents and oxygen release compositions respectively.

Comparison of the 8 figures shows that none of the current widely used methods of treating a composting pile worked as continuously or as significantly over time as the two methods of the present invention. In addition, the method of the present invention works significantly better than the present methods to the extend that composting facilities which use the windrow method outdoors would be able to meet the new proposed EPA standards simply, efficiently and cost effectively without the need to enclose the process or use vacuum methods of production.

It is understood that the examples and individual embodiments of the present invention as presented herein are intended to be illustrative only. Variations in the composting material selected, the thickness of the composting layer used, the frequency of turning the composting pile, the amount of compost to mix into the composting pile, the size of the composting pile, how to add the compost and the like are well within the skill in the art in view of the disclosure herein. Accordingly, the examples and embodiments are not intended to be limiting and the following claims are to be given their broadest interpretation within the spirit of the present invention as disclosed.

What is claimed is:

1. A method for reducing the volatile emissions from a pile of composting organic material comprising, covering the composting pile with a blanket layer of finished compost.

2. A method according to claim 1 which further comprises the additional steps of:
a) turning the composting pile with the blanket layer; and
b) covering the turned composting pile with another blanket layer of finished compost.

3. A method according to claim 1 wherein the layer of finished compost is at least about 2 inches in thickness.

4. A method according to claim 1 wherein the layer of finished compost is at least about 2 inches to about 8 inches.

5. A method according to claim 2 wherein a layer of compost is applied after each time the compost pile is turned.

6. A method according to claim 1 wherein the layer of finished compost is applied to composting piles that are using the windrow system of composting.

7. A method according to claim 1 wherein the emissions from the covered pile are measured at selected positions and additional finished compost added to the layer to any selected position where the emissions are above a desired amount.

8. A method for reducing the volatile emissions from a pile of composting organic material comprising adding a sufficient amount of finished compost to the pile to reduce the volatile emissions from the pile.

9. A method according to claim 8 wherein the finished compost is mixed with the composting organic material.

10. A method according to claim 8 wherein the finished compost is placed in a blanketing layer over the composting organic material.

11. A method according to claim 8 wherein the composting organic material is being composted using the windrow system of composting.

12. A method according to claim 8 wherein the amount of the amount of finished compost added to the composting pile is at least about 12% of the volume of the composting pile.
